(19) United States
(12) Patent Application Publication
(10) Pub. No.: US 2011/0242575 A1
(43) Pub. Date: Oct. 6, 2011

(54) Print Engine Page Streamlining

(76) Inventors: James E. Owen, Vancouver, WA (US); Joseph Bert Murdock, Camas, WA (US); Alex Lane Johnson, Washougal, WA (US); Michael S. Tillema, Tualatin, OR (US); Paul R. Henerlau, Portland, OR (US)

(21) Appl. No.: 12/750,299

(22) Filed: Mar. 30, 2010

(51) Int. Cl. G06K 1/00

(52) U.S. Cl. 358/1.15

(57) ABSTRACT

A system and method are provided for economically printing a physical media, such as paper. The method receives a print job with a plurality of logical pages, formatted as graphics commands. A raster image processor (RIP) renders the print job into a rasterized image. The rasterized image is accumulated as logical pages in a memory, as the print job is being rendered. The RIP sends the accumulated rasterized image logical pages to a printing device print engine. The print engine is warmed to an operating temperature in response to receiving the accumulated rasterized image logical pages. In one aspect, a printing device fuser roller is warmed to a temperature sufficient to melt toner on the physical medium. To conserve energy, the rasterized image logical pages are printed on a physical medium, while maintaining the print engine at the operating temperature between the printing of each logical page.

### BACKGROUND OF THE INVENTION

1. Field of the Invention

This invention generally relates to printing devices and, more particularly, to a system and method for economically printing documents by accumulating the logical pages of a raster image before sending them to the Print engine.

2. Description of the Related Art

As noted in Wikipedia, a laser printer is a common type of computer printer that rapidly produces high quality text and graphics on plain paper. As with digital photocopiers and multifunction printers (MFPs), laser printers employ a xerographic printing process but differ from analog photocopiers in that the image is produced by the direct scanning of a laser beam across the printer's photoreceptor. A laser beam projects an image of the page to be printed onto an electrically charged rotating drum coated with selenium. Photoconductivity removes charge from the areas exposed to light. Dry ink (toner) particles are then electrostatically picked up by the drum's charged areas. The drum then prints the image onto paper by direct contact and heat, which fuses the ink to the paper.

Laser printers have many significant advantages over other types of printers. Unlike impact printers, laser printer speed can vary widely, and depends on many factors, including the graphic intensity of the job being processed. The fastest models can print over 200 monochrome pages per minute (12,000 pages per hour).

In comparison with the laser printer, most inkjet printers and dot-matrix printers simply take an incoming stream of data and directly imprint it in a slow lurching process that may include pauses as the printer waits for more data. A laser printer is unable to work this way because such a large amount of data needs to output to the printing device in a rapid, continuous process. The printer cannot stop the mechanism precisely enough to wait until more data arrives, without creating a visible gap or misalignment of the dots on the printed page. Instead, the image data is built up and stored in a large bank of memory capable of representing every dot on the page. In other words, data for entire page must be saved in memory, so that the page can be printed with interruptions.

FIG. 1 depicts a process for generating raster image data (prior art). There are several steps involved in the laser printing process. First, raster image data is generated. Each horizontal strip of dots across the page is known as a raster line or scan line. Creating the image to be printed is done by a raster image processor (RIP), typically built into the laser printer, or in a computer or server sourcing documents to the printer. The source material may be encoded in any number of special page description languages such as Adobe PostScript (PS), HP Printer Command Language (PCL), or Microsoft XML Page Specification (XPS), as well as unformatted text-only data. The RIP uses the page description language (PDL) to generate a bitmap of the final page in the raster memory. Once the entire page has been rendered in raster memory, the printer is ready to begin the process of sending the rasterized stream of dots to the paper in a continuous stream.

Rasterization is the task of taking an image described in a vector graphics format (shapes) and converting it into a raster image (pixels or dots) for output on a video display or printer, or for storage in a bitmap file format. The term rasterization can in general be applied to any process by which vector information can be converted into a raster format.

For a fully graphical output using a page description language, a minimum of 1 megabyte of memory is needed to store an entire monochrome letter/A4 sized page of dots at 300 dpi. At 300 dpi, there are 90,000 dots per square inch (300 dots per linear inch). A typical. 8.5×11 sheet of paper has 0.25 inch margins, reducing the printable area to 8.0×10.5 inches, or 84 square inches. 84 sq/in×90,000 dots per sq/in=7,560,000 dots. Meanwhile 1 megabyte=1048576 bytes, or 8,388,608 bits, which is just large enough to hold the entire page at 300 dpi, leaving about 100 kilobytes to spare for use by the raster image processor.

In a color printer, each of the four CYMK toner layers is stored as a separate bitmap, and all four layers are typically preprocessed before printing begins, so a minimum of 4 megabytes is needed for a full-color letter-size page at 300 dpi. Memory requirements increase with the square of the dpi, so 600 dpi requires a minimum of 4 megabytes for monochrome, and 16 megabytes for color at 600 dpi. Some printers are capable of variable size dots and interstitial dots; these additional functions may require many times more memory over the minimums described herein.

FIG. 2 is a diagram depicting the application of a charge to a photosensitive drum (prior art). A primary charge roller projects an electrostatic charge onto the photoreceptor (otherwise named the photoconductor unit), a revolving photosensitive drum or belt, which is capable of holding an electrostatic charge on its surface while it is in the dark. In older printers, a corona wire is positioned parallel to the drum. An DC bias is applied to the primary charge roller to remove any residual charges left by previous images. The roller also applies a DC bias on the drum surface to ensure a uniform negative potential. The desired print density is modulated by this DC bias.

FIG. 3 is a diagram depicting the writing of a bitmap on the photosensitive drum using an exposure technique (prior art). The laser is aimed at a rotating polygonal mirror, which directs the laser beam through a system of lenses and mirrors onto the photoreceptor. The beam sweeps across the photoreceptor at an angle to make the sweep straight across the page. The cylinder continues to rotate during the sweep and the angle of sweep compensates for this motion. The stream of rasterized data held in memory turns the laser on and off to form the dots on the cylinder. Some printers switch an array of light emitting diodes (LEDs) spanning the width of the page. Like laser printers, these devices operate by heating the drum to a temperature sufficient to melt applied dry toner. The laser or LEDs neutralizes (or reverses) the charge on the black parts of the image, leaving a static electric negative image on the photoreceptor surface to lift the toner particles.

In the development step, the surface with the latent image is exposed to toner, fine particles of dry plastic powder mixed with carbon black or coloring agents. The charged toner particles are given a negative charge, and are electrostatically attracted to the photoreceptor's latent image, the areas touched by the laser. Because like charges repel, the negatively charged toner particles do not touch the drum where the negative charge remains.

The overall darkness of the printed image is controlled by the high voltage charge applied to the supply toner. Once the charged toner has jumped the gap to the surface of the drum, the negative charge on the toner itself repels the supply toner and prevents more toner from jumping to the drum. If the voltage is low, only a thin coat of toner is needed to stop more toner from transferring. If the voltage is high, then a thin coating on the drum is too weak to stop more toner from transferring to the drum. More supply toner will continue to jump to the drum until the charges on the drum are again high enough to repel the supply toner. At the darkest settings the supply toner voltage is high enough that it will also start coating the drum where the initial unwritten drum charge is still present, and will give the entire page a dark shadow.

In the transference step, the photoreceptor is pressed or rolled over paper, transferring the image. Higher-end machines may use a positively charged transfer roller on the back side of the paper to pull the toner from the photoreceptor to the paper.

FIG. 4 is a diagram depicting the step of fusing, where toner is melted onto paper using a combination of heat and pressure (prior art). The paper passes through rollers in the fuser assembly which heat (up to 200 Celsius) and pressure bond the plastic powder to the paper. One roller is usually a hollow tube (heat roller) and the other is a rubber backing roller (pressure roller). A radiant heat lamp is suspended in the center of the hollow tube, and its infrared energy uniformly heats the roller from the inside. For proper bonding of the toner, the fuser roller must be uniformly hot.

The fuser accounts for up to 90% of a printer's power usage. The heat from the fuser assembly can damage other parts of the printer, so it is often ventilated by fans to move the heat away from the interior. The primary power saving feature of most copiers and laser printers is to turn off the fuser and let it cool. Resuming normal operation requires waiting for the fuser to return to operating temperature before printing can begin.

Some printers use a very thin flexible metal fuser roller, so there is less mass to be heated and the fuser can more quickly reach operating temperature. This both speeds printing from an idle state and permits the fuser to turn off more frequently to conserve power. If paper moves through the fuser more slowly, there is more roller contact time for the toner to melt, and the fuser can operate at a lower temperature. Smaller, inexpensive laser printers typically print slowly, due to this energy-saving design, compared to large high speed printers where paper moves more rapidly through a high-temperature fuser with a very short contact time. Following the fusing process, the photoreceptor is cleaned.

As noted above, some so-called laser printers use a linear array of LEDs to write the light on the drum. The fuser can also be an infrared oven, a heated pressure roller, or a xenon flash lamp. The warm up process that a laser printer goes through when power is initially applied to the printer consists mainly of heating the fuser element.

FIG. 5 is a graph depicting a print engine warm up cycle associated with a multi-page print job (prior art). When a user is printing a complex job, there can be considerable energy wasted between printed pages. Conventionally, a page to be printed is rendered, then the rendered image is printed on paper. while the next page is being rendered. In order to print a page, the print engine must be brought to a “warm” state, where toner and fusers must be at operating temperature. This warm up phase can consume considerable energy relative to the total energy consumed to print the actual page. If another rendered page is not immediately available, the print engine may start to cool down the toner and fuser to extend the life of the hardware and supplies. When the next page is ready, the toner and fuser may need to be warmed up again, consuming considerable energy. With a complex print job requiring extensive rendering time, this warm-up and cool-down cycle occurs with every page, greatly increasing the total energy used to process the print job.

Most printers are judged by the first page out time and the last page out time. A great deal of effort has been invested by manufacturers in optimizing the first page out time, many times at the expense of the energy waste. However, for most users the first page out time is irrelevant, and even a small delay in the last page out time may be acceptable if some energy savings can be achieved.

Given this conventional situation of wasting energy in the printing of complex jobs, many printer manufacturers have focused on developing fusers that are more efficient, i.e. Instant-On Fusers that require less energy to heat up, or have developed toner that does not require as much heat/energy to function. While these changes can help reduce energy consumption, they still require a significant amount of energy to be brought up to temperature from a cool-down state. Additionally, these changes do not allow a print engine to function at its most-efficient top speed.

It would be advantageous if a complex print job could be pre-rendered before the engine is warmed up, so that the repeated warm up/cool down cycles associated with a conventional job can be reduced to a single cycle.

### SUMMARY OF THE INVENTION

The effect of the invention described herein is to collapse the warm up/cool down cycles of a print engine, so that an entire print job can be printed at the most efficient maximum speed supported by the engine. Multiple jobs, or multiple pages within a single job, are consolidated when printing. Altering the delivery of printouts of jobs or individual pages improves energy usage in printers by eliminating at least some job warm up cycles by the avoidance of delays between pages. The alterations can involve time shifting, location shifting, or resource shifting of the rendering process.

Accordingly, a method is provided for economically printing a physical media, such as paper. The method receives a print job with a plurality of logical pages, formatted as graphics commands. A raster image processor (RIP) renders the print job into a rasterized image. The rasterized image is accumulated as logical pages in a memory, as the print job is being rendered. The RIP sends the accumulated rasterized image logical pages to a printing device print engine. In one aspect, the print job is received by a computer embedded RIP driver application, and the computer embedded RIP sends the accumulated rasterized image to a printing device print engine. Alternately, a printing device embedded RIP driver application receives the print job. As explained in more detail below, the RIP and logical page accumulation function may be performed by a print server, or distributed between the printing device and client computer, between the client computer and print server, between the print server and printing device, or among all three.

The print engine is warmed to an operating temperature in response to receiving the accumulated rasterized image logical pages. In one aspect, a printing device fuser roller is warmed to a temperature sufficient to melt toner on the physical medium. The rasterized image logical pages are printed on a physical medium, while maintaining the print engine at the operating temperature between the printing of each logical page.

In a simple variation of the method, the accumulated rasterized image is sent after the final logical page in the print job has been rendered, and a (single) warm up time period occurs before printing a first rasterized image logical page. The warm up time period is defined as the period of time between when a first page of accumulated rasterized image is received at the print engine, and the print engine reaches operating temperature. Alternately, the method estimates a rendering time, which is defined as the time required to completely render the print job. Then, a warm up signal is sent to the print engine to minimize the above-defined warm up time period.

Additional details of the above-described method and a system for economically operating a printing device are presented below.

### BRIEF DESCRIPTION OF THE DRAWINGS

FIG. 1 depicts a process for generating raster image data (prior art).

FIG. 2 is a diagram depicting the application of a charge to a photosensitive drum (prior art).

FIG. 3 is a diagram depicting the writing of a bitmap on the photosensitive drum using an exposure technique (prior art).

FIG. 4 is a diagram depicting the step of fusing, where toner is melted onto paper using a combination of heat and pressure (prior art).

FIG. 5 is a graph depicting a print engine warm up cycle associated with a multi-page print job (prior art).

FIG. 6 is a schematic block diagram of a system for economically operating a printing device.

FIGS. 7A through 7C are explicit variations of the system of FIG. 6.

FIG. 8 is a timing diagram of a first raster image accumulation and warm up method.

FIG. 9 is a timing diagram of a second raster image accumulation and warm up method.

FIG. 10 is a timing diagram of a third raster image accumulation and warm up method.

FIG. 11 is a timing diagram of a fourth raster image accumulation and warm up method.

FIGS. 12A and 12B respectively contrast a print job performed with conventional and accumulated rendering methods.

FIG. 13 is a flowchart depicting a method for economically printing physical media.

FIG. 14 is a flowchart illustrating a method for economically printing physical media.

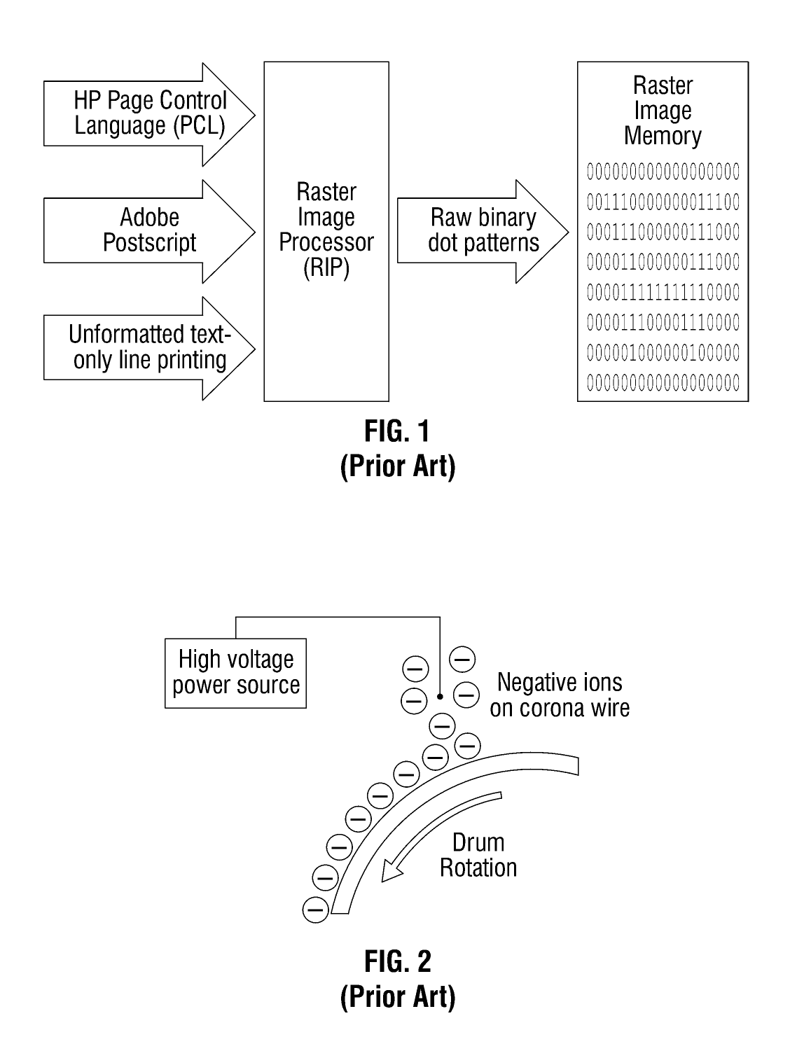

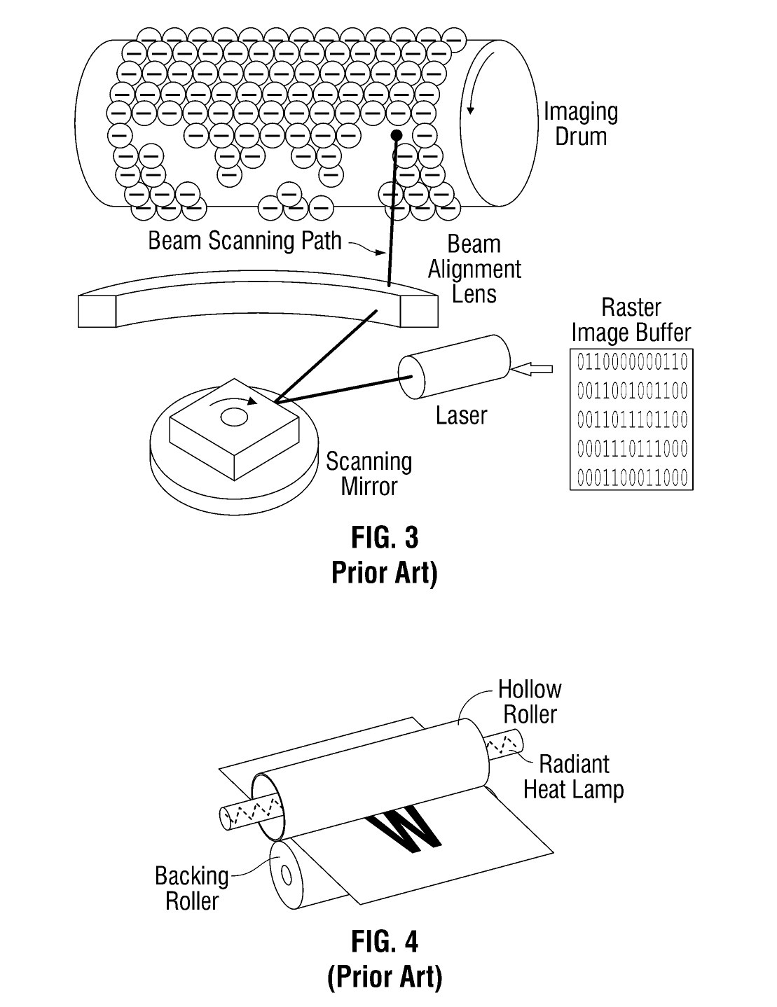

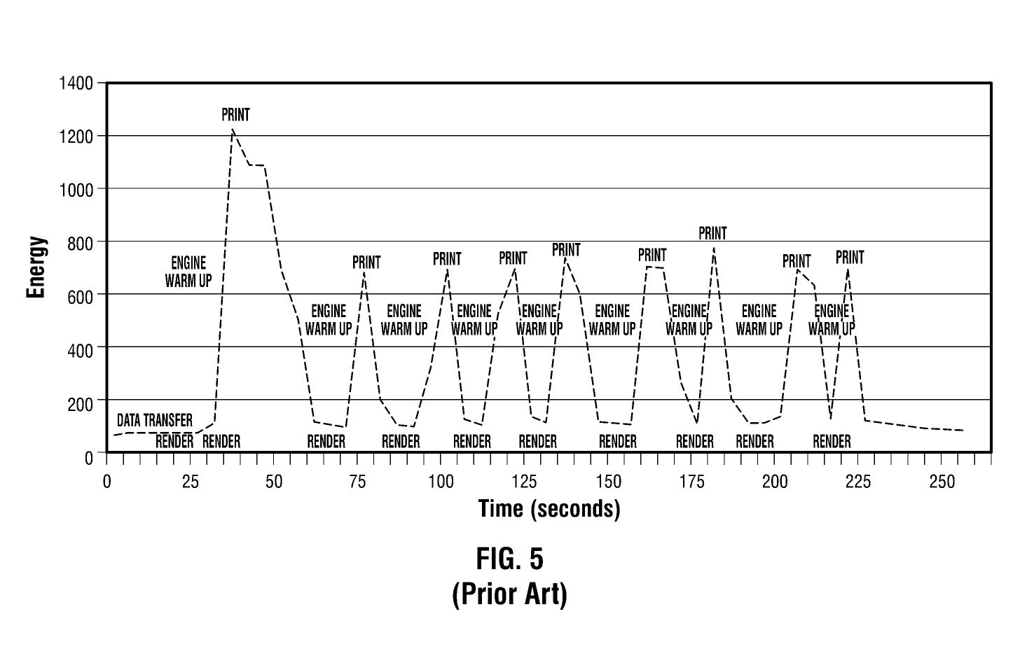

### DETAILED DESCRIPTION

As used in this application, the terms “component,” “module,” “system,” and the like are intended to refer to an automated computing system entity, such as hardware, firmware, a combination of hardware and software, software, software stored on a computer-readable medium, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

The printer and client devices described below may employ a computer system with a bus or other communication mechanism for communicating information, and a processor coupled to the bus for processing information. The computer system may also includes a main memory, such as a random access memory (RAM) or other dynamic storage device, coupled to the bus for storing information and instructions to be executed by processor. These memories may also be referred to as a computer-readable medium. The execution of the sequences of instructions contained in a computer-readable medium may cause a processor to perform some of the steps associated with position calculation. Alternately, these functions, or some of these functions may be performed in hardware. The practical implementation of a computer or printer employing a computer system would be well known to one with skill in the art.

As used herein, the term “computer-readable medium” refers to any medium that participates in providing instructions to a processor for execution. Such a medium may take many forms, including but not limited to, non-volatile media, volatile media, and transmission media. Non-volatile media includes, for example, optical or magnetic disks. Volatile media includes dynamic memory. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

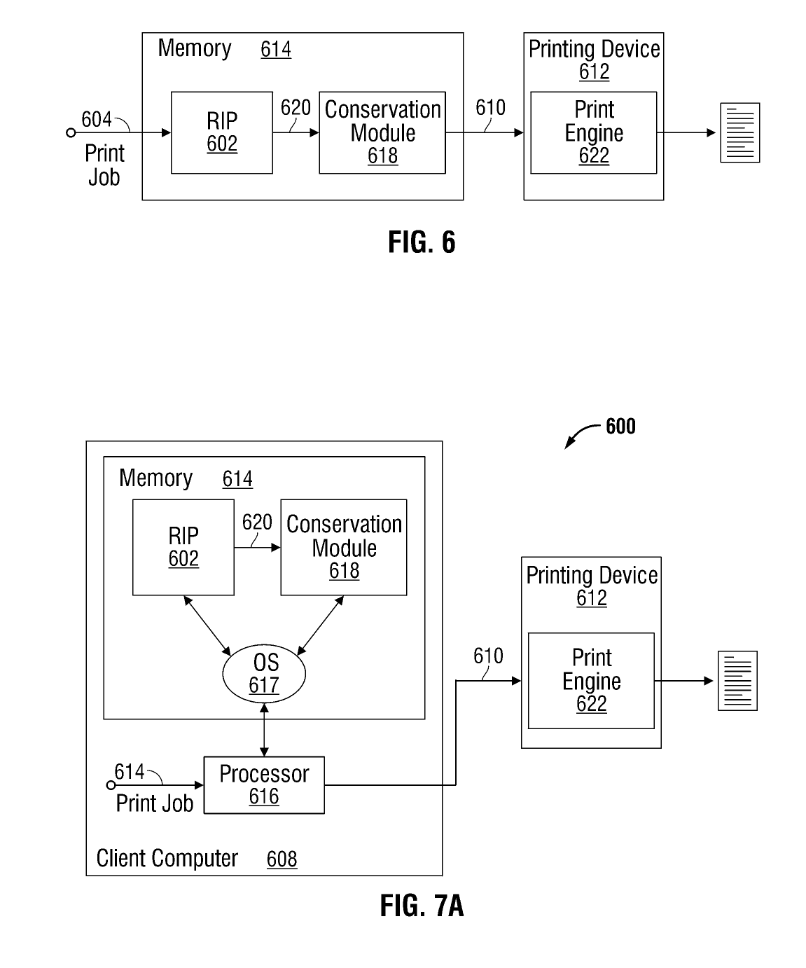

FIG. 6 is a schematic block diagram of a system for economically operating a printing device. The system 600 comprises a computer-readable memory 614. A raster image processor (RIP) 602 has an interface on line 604 to receive a print job with a plurality of logical pages, formatted as graphics commands. A logical page represents a page of presented information in electronic form. In the simplest case, a logical page is the same as the printed page of information. However, logical pages may be compressed, combined, or rearranged before printing. The RIP 602 has an interface on line 606 to supply the print job rendered into a rasterized image. Alternately, the RIP 602 receives a plurality of print jobs, and renders the plurality of print jobs into a single rasterized image group with a plurality of joined rasterized images.

A conservation module 618 has an interface connected to the RIP 602 on line 620. The conservation module 618 accumulates rasterized image logical pages in the memory 614 as the print job is being rendered. The conservation module 618 has an interface connected to line 610 for sending the accumulated rasterized image logical pages for printing. Again, the conservation module 618 may be enabled as software instructions stored in the computer-readable medium 614 and executed by a processor (not shown), or the conservation module may be a component of the RIP. Alternately, the conversation module may be a hardware device, such as a buffer memory (not shown), or a combination of hardware and software. As explained in more detail below, the memory can be located in the printer, a print server, or a client computer.

The printing device 612 has a print engine 622 with an interface connected to the conservation module on line 610. The printing device 612 can be a printer, multifunctional peripheral (MFP), copier, or fax machine. The print engine 622 warms itself to an operating temperature in response to receiving the accumulated rasterized image logical pages. The print engine 622 prints the rasterized image logical pages on a physical medium (e.g., paper), while maintaining the operating temperature between the printing of each logical page. In the case of a laser or LED printer, the print engine 622 warms a fuser roller to a temperature sufficient to melt toner on the physical medium. However, it should be understood that the concept of conserving energy by reducing warm up cycles is applicable to any kind of printer whose energy usage is ramped up prior to printing a page.

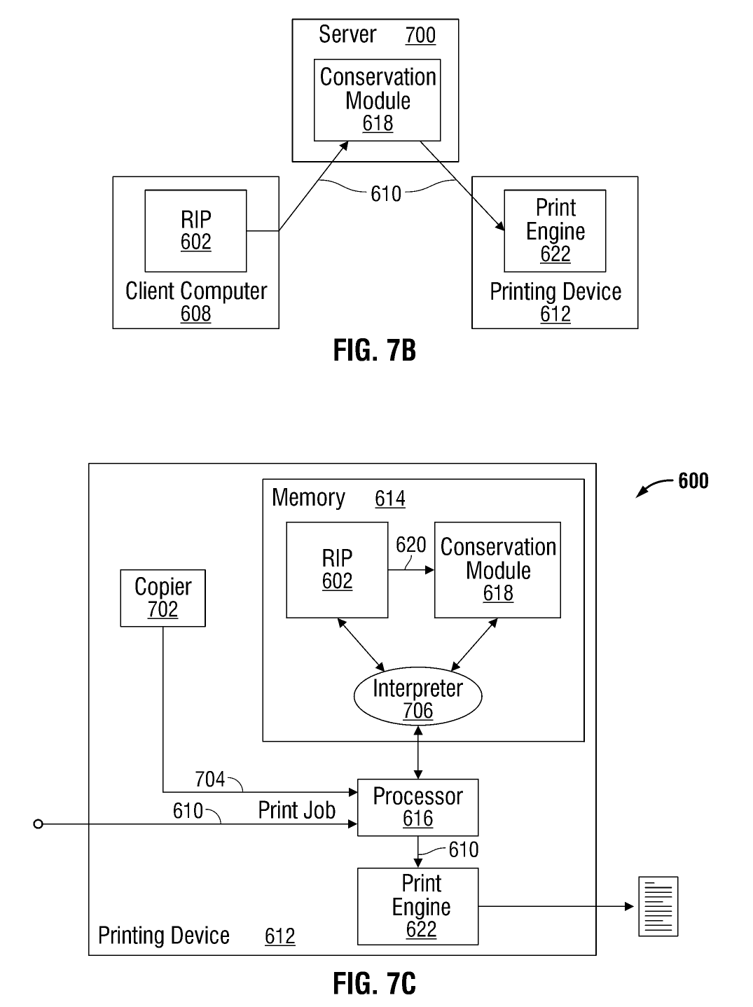

FIGS. 7A through 7C are explicit variations of the system of FIG. 6. In FIG. 7A, a client computer 608 has an interface on line 610 connected to the printing device 612. The RIP 602 is shown as a raster driver application embedded in the computer 608, enabled as software instructions stored in a computer-readable medium 614 and executed by a processor 616. As shown, an operating system (OS) 617, also enabled as software instructions stored in the computer-readable medium 614 and executed by the processor 616, intercedes between the RIP 602 and the processor 616, as is well understood in the art. Typically, the print job is supplied by a print driver (not shown), which is another example of a function enabled as software instructions stored in a computer-readable medium and executed by a processor, which is well understood in the art. In a RIP (raster driver), the PDL may be a series of DDI commands (Device dependant Interface) which is a PDL of sorts, but since it's meant for the printer driver, it's not called a PDL. Both a PDL and the stream of DDI commands are a series of graphics commands describing to print. Sometimes the driver changes the DDI commands to print in some special way (for example 4 up printing). Even when the RIP has been done in a raster driver, the printing device may perform additional processing. For example, it could scale the page images, or it translates from RGB colors into ink colors (CMYK).

Although not shown, it should be understood that an Ethernet processor, or some other communication device, may be interposed between the processor data/address bus and the output interface on line 610.

In FIG. 7B a print server 700 may be interposed between the client computer 608 and the printing device 612. Here, the conservation module 618 is located in the server 618, enabled as software, hardware, or a combination of hardware and software. In other aspects (not shown), the conservation module may be distributed between the server and client computer, the server and printing device, or the server, client computer, and printing device, so that the conservation module 618 in the server 700 only partially accumulates the logical pages.

In FIG. 7C, the RIP 602 is a raster driver application embedded in the printing device 612, enabled as software instructions stored in a computer-readable medium 614 and executed by a processor 616. The print job is supplied on line 610 by a print driver embedded in a network-connected client computer device or print server (not shown). Alternately, the printer 612 may include a copier module 702 connected to the RIP (via the interpreter 706 and processor 616) on line 704, and a user may generate the equivalent of a print job (e.g., use the printer pipeline) by copying a document. In another aspect not explicitly shown, the conservation module, but not the RIP are embedded in the printing device. In one more aspect, the conservation module is distributed among other network-connected components, so that the conservation module 618 embedded with the printing device only partially accumulates the logical pages.

As noted in the Background Section, the RIP process generates a large amount of data, which in turn, requires a large amount of memory. In earlier times memory was very expensive, and printer manufactures labored to offload memory related tasks to client computers and print servers. As a result, RIP processes and data spooling were not conventionally performed by printing devices. However, memory is now significantly cheaper. In recognition of this fact, the printing device of FIG. 7C moves against the tide of conventional thinking with the realization that memory-intensive tasks can be performed in a printing device, and more important, that some tasks are best performed at the printer. Thus, the printing device has enough memory to enable the accumulation of logical pages, and in some aspects (as shown), includes both the RIP and conservation module.

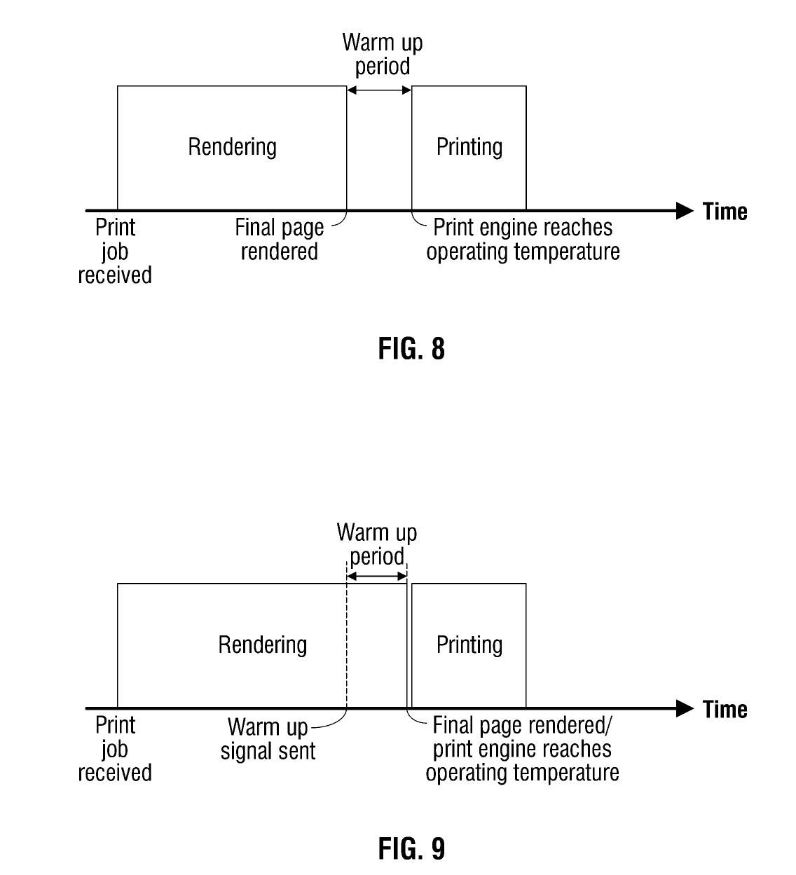

FIG. 8 is a timing diagram of a first raster image accumulation and warm up method. Referencing FIGS. 6, 7A-7C, and 8, in one aspect of the system 600, the conservation module 618 sends the accumulated rasterized image after a final logical page in the print job has been rendered, and the print engine 622 waits a warm up time period before printing the first rasterized image logical page. The warm up time period is defined as the period of time between when a first page of accumulated rasterized image is received at the print engine, and the print engine reaches operating temperature after the warm up period. For this example, it is assumed that there are no communication delays between the RIP and the print engine.

FIG. 9 is a timing diagram of a second raster image accumulation and warm up method. Referencing FIGS. 6, 7A-7C, and 9, in another aspect of the system, the conservation module 618 estimates a rendering time, which is defined as the time required to completely render the print job. The conservation module 618 sends a warm up signal to the print engine 633 to minimize the warm up time period (as defined above), and the print engine reaches operating temperature after the warm up period. For simplicity, it can be assumed that the warm up signal is sent via line 610. However, the warm up signal may be sent by other means, such as a WiFi link. The estimation of the rendering time may be based upon factors such as the number of logical pages in the print job, the print job file size, the graphics content of the print job, and combinations of the above-mentioned criteria.

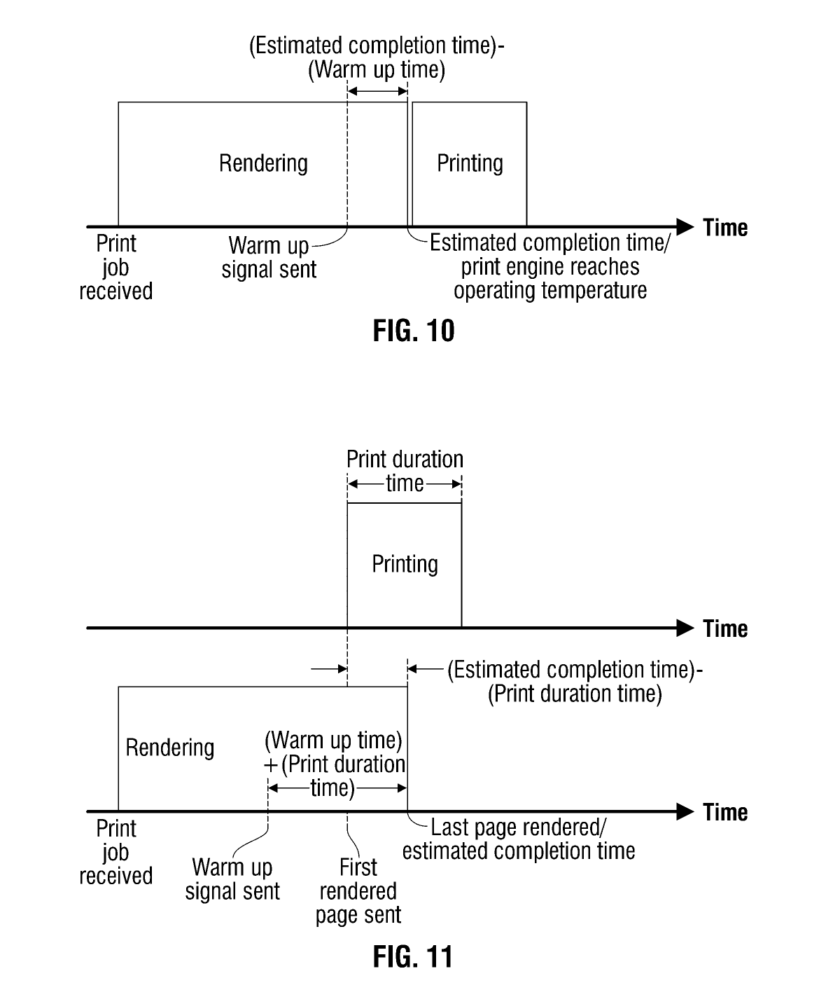

FIG. 10 is a timing diagram of a third raster image accumulation and warm up method. Referencing FIGS. 6, 7A-7C, and 10, in another aspect of the system, the conservation module 618 may estimate a completion time at which a final logical page in the print job will be rendered, and send the warm up signal at a time equal to (the completion time)−(the warm up time). Then, the conservation module 618 sends the accumulated rasterized image after the final logical page in the print job has been rendered. For this example, it is assumed that there are no communication delays and the estimated completion time matches the time at which the last page is actually rendered.

FIG. 11 is a timing diagram of a fourth raster image accumulation and warm up method. Referencing FIGS. 6, 7A-7C, and 11, in one other aspect of the system, the conservation module 618 may estimate the completion time at which a final logical page in the print job will be rendered, and estimate a print duration time, which is a time period required to print every logical page in the rasterized image. The conservation module 618 sends the warm up signal at a time equal to ((the completion time)−(the warm up time+print duration time)). The conservation module sends the first logical page as the rasterized image is still accumulating, at a time equal to (the completion time)−(the print duration time). For this example, it is assumed that there are no communication delays and the estimated completion time matches the time at which the last page is actually rendered.

The examples described above assume that the print engine responds immediately to the warm up signal. In other aspects not shown, the warm up signal may be sent with an embedded time reference, and the print engine begins the warm up process at the time indicated in the warm up signal.

### Functional Description

A typical printing device may use 13 watts of power in a sleep idle mode, 70 watts in awake idle, and ramp up from 70 watts to 900 watts to reach operating temperature. If the fuser has cooled down, because of waiting for rendering, then it needs to warm up. The maximum page warm up time is the time it takes for the fuser to go from room temperature to printing temperature. This time may not be noticeable if it is shorter than the page warm up and cool down. If the page rendering takes longer the maximum page cool down and warm up, then it will be measurable. Suppose it takes 30 seconds to render a page, but 5 seconds to cool down or up. Then, an extra 20 seconds will occur, in addition to the page cool down and warm up.

Rendering affects the size of the data drastically, which is important for the transmission time. In other words, unprocessed graphics can be much smaller than the final rasters, so that processing on an MFP may have negligible transmission time and a huge rendering time. While raster printing can render the pages much quicker, it may suffer in the transmission time. Thus, to make the graphs of FIGS. 8-9 more realistic, the effect of transmission time could be added to the warm up period. Likewise, the effect of transmission times could be added to the estimated (rendering) completion times of FIGS. 10-11.

Another issue with streamline timing is that the size of the job may not be known a priori. However, the economy of using this method depends upon this a priori knowledge. In addition to number of pages, some statistics about the graphics contents or the size of the data permits a more accurate estimate. In Windows printing, this can be done in the driver when spooling the OS graphics or PDL graphics (for high level PDLs).

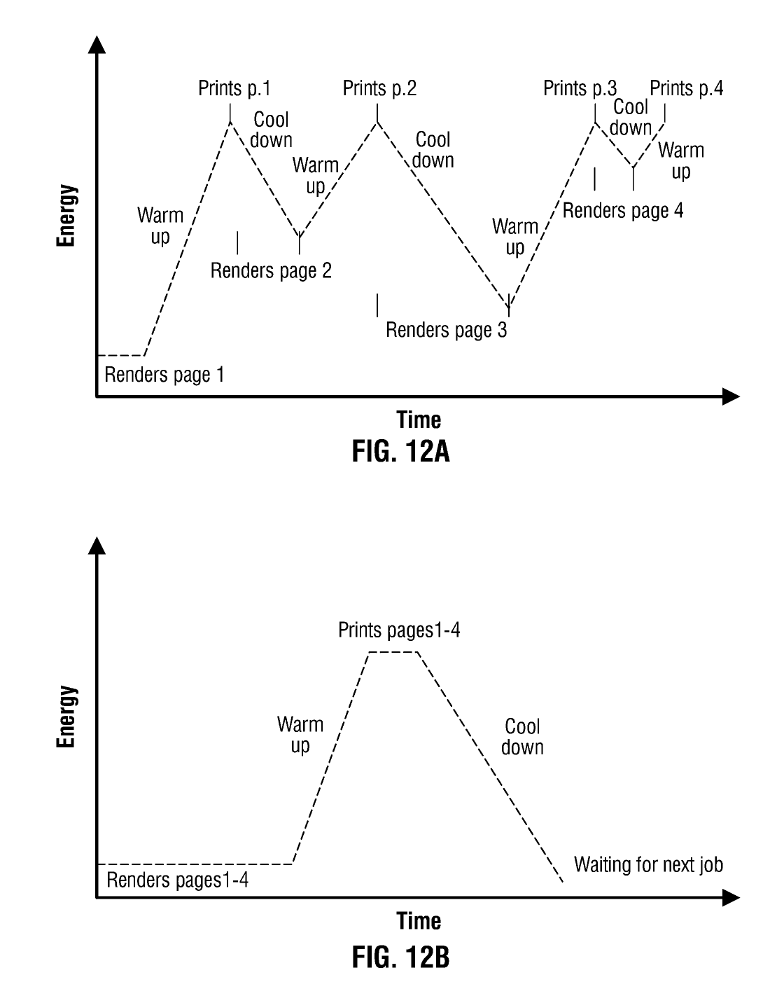

FIGS. 12A and 12B respectively contrast a print job performed with conventional and accumulated rendering methods. As shown in FIG. 12A, a conventional rendering method schedules processing as soon as the data is available, so that printing occurs in a render-print-render-print cycle or receive-print-receive-print cycle (for a raster driver). Page time shifting (FIG. 12B) consists of switching the cycles to render-render-print-print or receive-receive-print-print.

For example, a user needs to print a 4-page color document that contains text, graphics, and images. In contrast to the energy cycles depicted in FIG. 12A, the user selects the “economy” mode (or the print driver has been previously configured for economy). Since it is a complex document, the MFP begins rendering the complete job, and there is a noticeable delay before the job begins printing. The entire job is rendered and then sent to the MFP for printing. MFP warms up. With the rendering completed and the MFP warmed up, the MFP prints at engine speed. The printer driver UI must have an “Eco” selection, and the printer driver emits an “Eco delay” PJL command. The MFP identifies this Eco delay command and waits until job is completely rendered before warming up and printing.

In the simplest scheme, the rendered pages are saved until the rendering is complete. Then, the print engine begins warm up. While this method has the advantage of simplicity, it may increase the overall completion time associated with a print job. Otherwise, a prediction technique can be used to start the warm up before the job is completely rendered.

An interactive page delay technique would permit a user to override the timing of individual pages or the rest of the job. This can be used for proofing one page at a time, or if the user wishes to speed up the job at the expense of energy usage. Interactive page delays affect Nth-page printing times. This might be particularly valuable for mobile printing or printing from a USB stick, when a decent display is unavailable to view the pages before printing.

If page time-shifting management occurs external to the MFP, for example, when the control of rendering and page pace is performed on the host or cloud, the MFP is unaware that it is operating in an energy saving mode. Alternately, rendering occurs internal to the MFP, and the MFP controls the pace of the pages. Further, the rendering may occur on the host or cloud, but the MFP controls the pace of the pages. In a hybrid management technique, rendering is performed at the MFP, but it receives statistics to help in the control of the pace of the pages. Again, rendering may also be performed on the host or cloud, but statistics are sent to the MFP as soon as possible to help the MFP control the pace of the pages.

Page time-shifting timing prediction can be used to upgrade an open-ended job to a known job. The driver can accumulate page and graphics statistics when spooling and provide them to the MFP either as part of the print job or as a separate Windows color system (WCS) message. The predictions can be table driven, based upon real-time energy measurements, historical energy measurements, real-time timing measurements, and historical timing measurements.

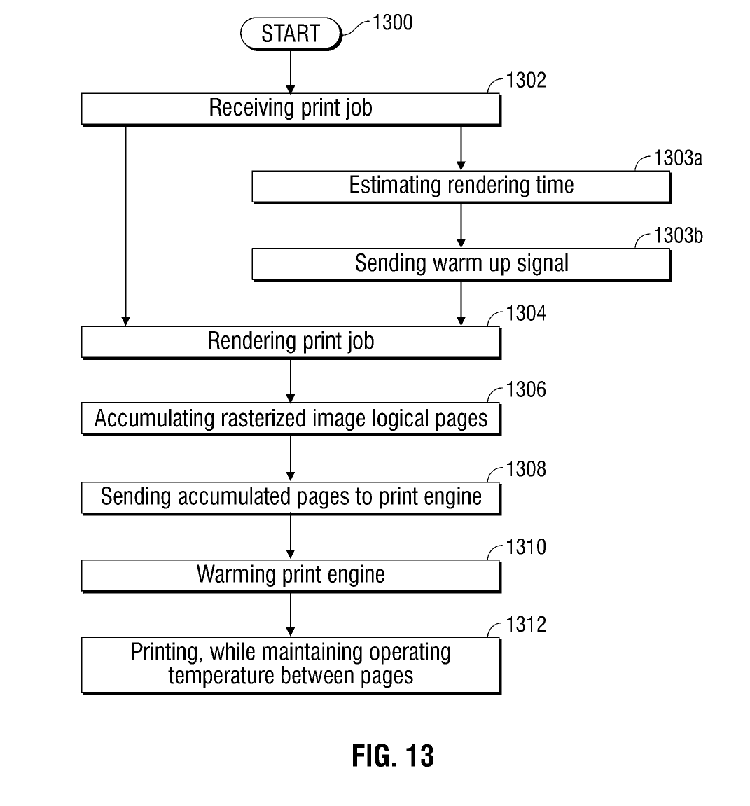

FIG. 13 is a flowchart depicting a method for economically printing physical media. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Typically however, the method is performed in the numerical order of the steps. The method starts at Step 1300.

Step 1302 receives a print job with a plurality of logical pages, formatted as graphics commands (e.g., DDI or PDL). In Step 1304 a raster image processor (RIP) renders the print job into a rasterized image. Step 1306 accumulates rasterized image logical pages in a memory as the print job is being rendered. In Step 1308 the RIP sends the accumulated rasterized image logical pages to a printing device print engine. Alternately, as shown in FIG. 6, a separate conservation module accumulates the logical pages, and sends the accumulated pages to the printing device. Step 1310 warms the print engine to an operating temperature in response to receiving the accumulated rasterized image logical pages. In one aspect, a printing device fuser roller is warmed to a temperature sufficient to melt toner on the physical medium. Step 1312 prints the rasterized image logical pages on a physical medium, maintaining the print engine at the operating temperature between the printing of each logical page.

In one aspect, receiving the print job in Step 1306 includes a computer (client computer or print server) embedded conservation module, enabled as hardware or a software instructions stored in a computer-readable medium and executed by a processor, at least partially accumulating the logical pages. Then, sending the accumulated rasterized image logical pages to the print engine in Step 1308 includes the computer embedded RIP sending the accumulated rasterized image to a printing device print engine. In a different aspect, Step 1306 includes a printing device embedded conservation module, enabled as hardware or software instructions stored in a computer-readable medium and executed by a processor, at least partially accumulating the logical pages.

In one aspect, sending the accumulated rasterized image logical pages to the print engine in Step 1308 includes sending the accumulated rasterized image after a final logical page in the print job has been rendered. Then, printing the rasterized image logical pages in Step 1312 includes waiting a warm up time period before printing a first rasterized image logical page, where the warm up time period is defined as the period of time between when a first page of accumulated rasterized image is received at the print engine, and the print engine reaches operating temperature.

In a different aspect, Step 1303a estimates a rendering time, which is defined as the time required to completely render the print job. The estimating of the rendering time can be based upon a criterion such as the number of logical pages in the print job, the print job file size, the graphics content of the print job, and combinations of the above-mentioned criteria. Step 1303b sends a warm up signal to the print engine to minimize the warm up time period.

For example, Step 1303a may estimate a completion time at which a final logical page in the print job will be rendered, and Step 1303b sends the warm up signal at a time equal to (the completion time)−(the warm up time). Then, Step 1308 sends the accumulated rasterized image after the final logical page in the print job has been rendered.

As another example, Step 1303a estimates a completion time at which a final logical page in the print job will be rendered, and estimates a print duration time, which is a time period required to print every logical page in the rasterized image. Step 1303b sends the warm up signal at a time equal to ((the completion time)−(the warm up time+print duration time)), and Step 1308 sends the first logical page as the rasterized image is still accumulating, at a time equal to (the completion time)−(the print duration time).

In another aspect, receiving the print job in Step 1302 includes receiving a plurality of print jobs, and rendering the print job into the rasterized image in Step 1304 includes rendering the plurality of print jobs into a rasterized image group with a plurality of joined raster images.

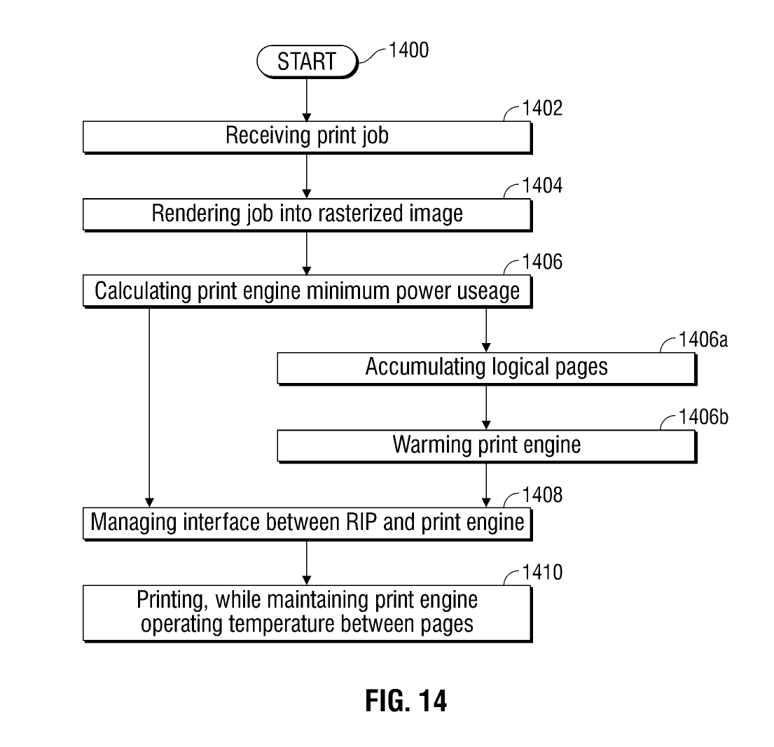

FIG. 14 is a flowchart illustrating a method for economically printing physical media. The method starts at Step 1400. In Step 1402 a RIP driver application, enabled as software instructions stored in a computer-readable medium and executed by a processor, receives a print job with a plurality of logical pages, formatted as graphics commands. In Step 1404 the RIP renders the print job into a rasterized image. In Step 1406 a conservation module, enabled as software instructions stored in a computer-readable memory and executed by a processor, calculates a minimum power needed by a print engine to print rasterized image logical pages on a physical medium. In one aspect, a minimum fuser power is calculated that is needed by a printing device print engine to print the rasterized image. In Step 1408 the conservation module manages an interface between the RIP and the print engine to insure that the minimum power is used. Alternately as noted above, this function may be preformed by a modified RIP.

In one aspect, calculating the minimum power needed by a print engine to print rasterized image logical pages in Step 1406 includes substeps. Step 1406a accumulates rasterized image logical pages in a memory as the print job is being rendered. Step 1406b warms a print engine to an operating temperature in response to receiving the accumulated rasterized image logical pages. Then, Step 1410 prints the rasterized image logical pages on the physical medium, maintaining the print engine at operating temperature between the printing of each logical page.

A system and method has been provided by economically managing a printing device. Examples of specific modules and process steps have been given to illustrate the invention, but the invention is not limited to merely these examples. Other variations and embodiments of the invention will occur to those skilled in the art.

We claim:

1. A method for economically printing physical media, the method comprising:
receiving a print job with a plurality of logical pages, formatted as graphics commands;
a raster image processor (RIP) rendering the print job into a rasterized image;
accumulating rasterized image logical pages in a memory as the print job is being rendered;
the RIP sending the accumulated rasterized image logical pages to a printing device print engine;
warming the print engine to an operating temperature in response to receiving the accumulated rasterized image logical pages; and,
printing the rasterized image logical pages on a physical medium, maintaining the print engine at the operating temperature between the printing of each logical page.

2. The method of claim 1 wherein warming the print engine to the operating temperature includes warming a printing device fuser roller to a temperature sufficient to melt toner on the physical medium.

3. The method of claim 1 wherein sending the accumulated rasterized image logical pages to the print engine includes sending the accumulated rasterized image after a final logical page in the print job has been rendered; and,
wherein printing the rasterized image logical pages includes waiting a warm up time period before printing a first rasterized image logical page, where the warm up time period is defined as the period of time between when a first page of accumulated rasterized image is received at the print engine, and the print engine reaches operating temperature.

4. The method of claim 1 further comprising:
estimating a rendering time, which is defined as the time required to completely render the print job; and,
sending a warm up signal to the print engine to minimize a warm up time period, where the warm up time period is defined as the period of time between when a first page of accumulated rasterized image is received at the print engine, and the print engine reaches operating temperature.

5. The method of claim 4 wherein estimating the rendering time includes estimating a completion time at which a final logical page in the print job will be rendered;
wherein sending the warm up signal includes sending the warm up signal at a time equal to (the completion time)−(the warm up time); and,
wherein sending the accumulated rasterized image logical pages to the print engine includes sending the accumulated rasterized image after the final logical page in the print job has been rendered.

6. The method of claim 4 wherein estimating the rendering time includes estimating a completion time at which a final logical page in the print job will be rendered, and estimating a print duration time, which is a time period required to print every logical page in the rasterized image;
wherein sending the warm up signal includes sending the warm up signal at a time equal to ((the completion time)−(the warm up time +print duration time)); and,
wherein sending the accumulated rasterized image logical pages to the print engine includes sending the first logical page as the rasterized image is still accumulating, at a time equal to (the completion time)−(the print duration time).

7. The method of claim 4 wherein estimating the rendering time includes estimating the rendering time based upon a criterion selected from a group consisting of the number of logical pages in the print job, the print job file size, the graphics content of the print job, and combinations of the above-mentioned criteria.

8. The method of claim 1 wherein receiving the print job includes receiving a plurality of print jobs; and,
wherein rendering the print job into the rasterized image includes rendering the plurality of print jobs into a rasterized image group with a plurality of joined raster images.

9. The method of claim 1 wherein accumulating rasterized image logical pages includes a computer embedded conservation module application, enabled as software instructions stored in a computer-readable medium and executed by a processor, at least partially accumulating the logical pages; and,
wherein sending the accumulated rasterized image logical pages to the print engine includes the computer sending the accumulated rasterized image to a printing device print engine.

10. The method of claim 1 wherein accumulating rasterized image logical pages includes a printing device embedded conservation module application, enabled as software instructions stored in a computer-readable medium and executed by a processor, at least partially accumulating the logical pages.

11. A method for economically printing physical media, the method comprising:
a raster image processor (RIP) driver application, enabled as software instructions stored in a computer-readable medium and executed by a processor, receiving a print job with a plurality of logical pages, formatted as graphics commands;
the RIP rendering the print job into a rasterized image;
a conservation module, enabled as software instructions stored in a computer-readable memory and executed by a processor, calculating a minimum power needed by a print engine to print rasterized image logical pages on a physical medium; and,
the conservation module managing an interface between the RIP and the print engine to insure that the minimum power is used.

12. The method of claim 11 wherein calculating the minimum power needed by a print engine to print rasterized image logical pages includes:
accumulating rasterized image logical pages in a memory as the print job is being rendered;
warming a print engine to an operating temperature in response to receiving the accumulated rasterized image logical pages; and,
the method further comprising:
printing the rasterized image logical pages on the physical medium, maintaining the print engine at operating temperature between the printing of each logical page.

13. The method of claim 11 wherein calculating the minimum power needed by a print engine to print rasterized image logical pages includes calculating a minimum fuser power needed by a printing device print engine to print the rasterized image.

14. A system for economically operating a printing device, the system comprising:
a computer-readable memory;
a raster image processor (RIP) having an interface to receive a print job with a plurality of logical pages, formatted as graphics commands, and an interface to supply the print job rendered into a rasterized image;
a conservation module having an interface connected to the RIP, the conservation module accumulating rasterized image logical pages in the memory as the print job is being rendered, and having an interface for sending the accumulated rasterized image logical pages for printing; and,
a printing device print engine having an interface connected to the conservation module, the print engine warming itself to an operating temperature in response to receiving the accumulated rasterized image logical pages, and printing the rasterized image logical pages on a physical medium, while maintaining the operating temperature between the printing of each logical page.

15. The system of claim 14 wherein the print engine warms a fuser roller to a temperature sufficient to melt toner on the physical medium.

16. The system of claim 14 wherein the conservation module sends the accumulated rasterized image after a final logical page in the print job has been rendered; and,
wherein the print engine waits a warm up time period before printing a first rasterized image logical page, where the warm up time period is defined as the period of time between when a first page of accumulated rasterized image is received at the print engine, and the print engine reaches operating temperature after the warm up period.

17. The system of claim 14 wherein the conservation module estimates a rendering time, which is defined as the time required to completely render the print job, and sends a warm up signal to the print engine to minimize a warm up time period, where the warm up time period is defined as the period of time between when a first page of accumulated rasterized image is received at the print engine, and the print engine reaches the operating temperature after the warm up period.

18. The system of claim 17 wherein the conservation module estimates a completion time at which a final logical page in the print job will be rendered, sends the warm up signal at a time equal to (the completion time)−(the warm up time), and sends the accumulated rasterized image after the final logical page in the print job has been rendered.

19. The system of claim 17 wherein the conservation module estimates a completion time at which a final logical page in the print job will be rendered, estimates a print duration time, which is a time period required to print every logical page in the rasterized image, sends the warm up signal at a time equal to ((the completion time)−(the warm up time+print duration time)), and sends the first logical page as the rasterized image is still accumulating, at a time equal to (the completion time)−(the print duration time).

20. The system of claim 17 wherein the conservation module estimates the rendering time based upon a criterion selected from a group consisting of the number of logical pages in the print job, the print job file size, the graphics content of the print job, and combinations of the above-mentioned criteria.

21. The system of claim 14 wherein the RIP receives a plurality of print jobs, and renders the plurality of print jobs into a single rasterized image group with a plurality of joined rasterized images.

22. The system of claim 14 further comprising:
a network server having a network interface connected to a client computer and the printing device;
wherein the conservation module is an application embedded in the server, enabled as software instructions stored in a computer-readable medium and executed by a processor, at least partially accumulating the logical pages.

23. The system of claim 14 wherein the conservation module is an application embedded in the printing device, enabled as software instructions stored in a computer-readable medium and executed by a processor, at least partially accumulating the logical pages.
